(19) United States
(12) Patent Application Publication
(10) Pub. No.: US 2021/0037709 A1
(43) Pub. Date: Feb. 11, 2021

(54) Electrical Cut Quality System for Harvesters

(71) Applicant: CNH INDUSTRIAL AMERICA LLC, New Holland, PA (US)

(72) Inventor: Kevin M. Smith, Narvon, PA (US)

(73) Assignee: CNH Industrial America LLC, New Holland, PA (US)

(21) Appl. No.: 16/531,176

(22) Filed: Aug. 5, 2019

(51) Int. Cl. A01D 41/127; A01D 41/14

(52) U.S. Cl. CPC A01D 41/1274; A01D 41/141

(57) ABSTRACT

A system for determining the cut quality of a crop by a harvester includes an electrode maintained at voltage above ground. The electrode is mounted downstream of a cutter bar on the harvester. The electrode communicates with a controller which measures changes in an electrical parameter, such as voltage or current, between the electrode and ground. The electrode is positioned to ride at a particular height above the ground specific to a particular crop. Crop stubble left by crop which is cut cleanly by the harvester does not contact the electrode. Crop stubble left by crop which is not cut properly will engage the electrode and effect a change in the electrical parameter measured by the controller. The controller reports changes in the electrical parameter indicative of cut quality to the operator of the harvester via a display device thereby allowing the operator to take corrective action in harvester operation.

### FIELD OF THE INVENTION

This invention concerns agricultural harvesters having sensors which indicate the quality of crop cut.

### BACKGROUND

Harvesters such as windrowers, tractors, balers and mowers, both self-propelled and towed, generally use a cutter bar having multiple rotating discs with cutting blades for cutting crop. It is difficult for harvester operators to determine if crop is being cut cleanly when the cut crop is thrown immediately on top of the cut stubble, thereby inhibiting a visual evaluation of the crop cut quality. There is clearly an opportunity to improve harvester operation by employing a sensor system which evaluates the quality of the cut and reports the cut quality to the operator, allowing for adjustment of harvester operation to maintain acceptable cut quality.

### SUMMARY

The invention concerns a system for determining the cut quality of a crop by a harvester. In an example embodiment the system comprises an electrode positionable on the harvester. The electrode is electrically insulated from the harvester. A voltage source applies a voltage difference between the electrode and the harvester. A controller is in electrical communication with the electrode and the harvester. The controller is adapted to measure an electrical parameter between the electrode and the harvester and generate signals indicative of the electrical parameter. The signals are a measure of cut quality of the crop by the harvester.

In a particular example embodiment, the controller measures the electrical parameter between the electrode and a frame of the harvester. By way of example, the electrical parameter may comprises a voltage drop across the electrode and the harvester. In another example, the electrical parameter comprises a current between the electrode and the harvester. In an example embodiment, the electrode comprises an elongate electrical conductor. The example may further comprise a shroud surrounding a portion of the elongate electrical conductor. An example embodiment may further comprise a display device in communication with the controller. The display device is adapted to receive the signals from the controller and display the signals to an operator of the harvester.

Another example embodiment of a system for determining the cut quality of a crop by a harvester comprises first and second electrodes positionable in spaced relation on the harvester. The electrodes are electrically insulated from one another and from the harvester. A voltage source applies a voltage difference between the first and second electrodes. A controller is in electrical communication with the electrode. By way of example the controller is adapted to measure an electrical parameter between the first electrode and the harvester and generate signals indicative of the electrical parameter. The signals are a measure of cut quality of the crop by the harvester.

In an example embodiment the electrical parameter comprises a voltage drop across the first and second electrodes. In another example embodiment the electrical parameter comprises a current between the first and second electrodes. By way of example, the first and second electrodes comprise first and second elongate electrical conductors. An example embodiment may further comprise a shroud surrounding a portion of the first and second elongate electrical conductors. An example embodiment of a system may further comprise a display device in communication with the controller. The display device is adapted to receive the signals from the controller and display the signals to an operator of the harvester.

The invention further encompasses a harvester for cutting a crop. In an example embodiment the harvester comprises a frame. A cutter bar is mounted on the frame. A plurality of cutting elements are mounted on the cutter bar. An electrode is mounted on the frame downstream from the cutter bar. The electrode is electrically insulated from the frame. The electrode faces stubble of the crop. A voltage source applies a voltage difference between the electrode and the frame. A controller is in electrical communication with the electrode and the frame. The controller is adapted to measure an electrical parameter between the electrode and the frame and generate signals indicative of the electrical parameter, wherein the signals are a measure of cut quality of the crop by the harvester.

In an example embodiment the electrical parameter comprises a voltage drop across the electrode and the frame. In another example embodiment the electrical parameter comprises a current between the electrode and the frame. By way of example the electrode comprises an elongate electrical conductor. In an example embodiment the elongate electrical conductor spans the same width as the cutter bar. A further example embodiment comprises a plurality of the electrodes. By way of example in this embodiment, each of the electrodes comprises an elongate electrical conductor, and each electrical conductor has a span less than the width of the cutter bar.

In a specific example embodiment, the plurality of the electrical conductors spans the same width as the cutter bar. An example harvester according to the invention may further comprise a display device in communication with the controller. The display device is adapted to receive the signals from the controller and display the signals to an operator of the harvester. An example embodiment may further comprise an adjustable mount positioned between the frame and the electrode for adjusting a position of the electrodes relatively to the stubble.

In a practical embodiment, an example harvester according to the invention comprises at least two ground engaging wheels mounted on the frame. A tongue is attached to the frame. The tongue is attachable to a tractor for drawing the harvester. Further by way of example, a drive system may be operationally associated with the cutter bar. An actuator is operationally associated with the drive system. The actuator is adapted to control a cutting speed of the cutter bar via the drive system. In such an example embodiment the actuator receives the signals from the controller and adjusts the cutting speed of the cutter bar pursuant to a control method executed by the controller.

An example harvester according to the invention may also comprise a tractor having a chassis wherein the frame is mounted on the chassis. Further by way of example a drive system is operationally associated with the cutter bar. An actuator is operationally associated with the drive system. The actuator is adapted to control a cutting speed of the cutter bar via the drive system. In this example the actuator receives the signals from the controller and adjusts the cutting speed of the cutter bar pursuant to a control method executed by the controller.

The invention also encompasses a harvester for cutting a crop, an example of which comprises a frame. A cutter bar is mounted on the frame. A plurality of cutting elements are mounted on the cutter bar. First and second electrodes are mounted in spaced relation on the frame downstream from the cutter bar. The electrodes are electrically insulated from one another and from the frame. The electrodes face stubble of the crop. A voltage source applies a voltage difference between the first and second electrodes. A controller is in electrical communication with the first and second electrodes. The controller is adapted to measure an electrical parameter between the first and second electrodes and generate signals indicative of the electrical parameter. The signals are a measure of cut quality of the crop by the harvester.

### BRIEF DESCRIPTION OF THE DRAWINGS

FIG. 1 is an isometric view of an example harvester using an electrical cut quality system according to the invention;

FIG. 2 is a plan view of components of the harvester shown in FIG. 1;

FIGS. 2A and 2B are plan views of alternate embodiments of harvesters according to the invention;

FIG. 3 is a side view of another example harvester using an electrical cut quality system according to the invention;

FIG. 4 is a partial sectional side view of a portion of the harvester shown in FIG. 3;

FIG. 5 is a schematic drawing illustrating operation of an example electrical cut quality system according to the invention; and

FIG. 6 is an isometric view of a portion of a harvester using an example cut quality system according to the invention.

### DETAILED DESCRIPTION

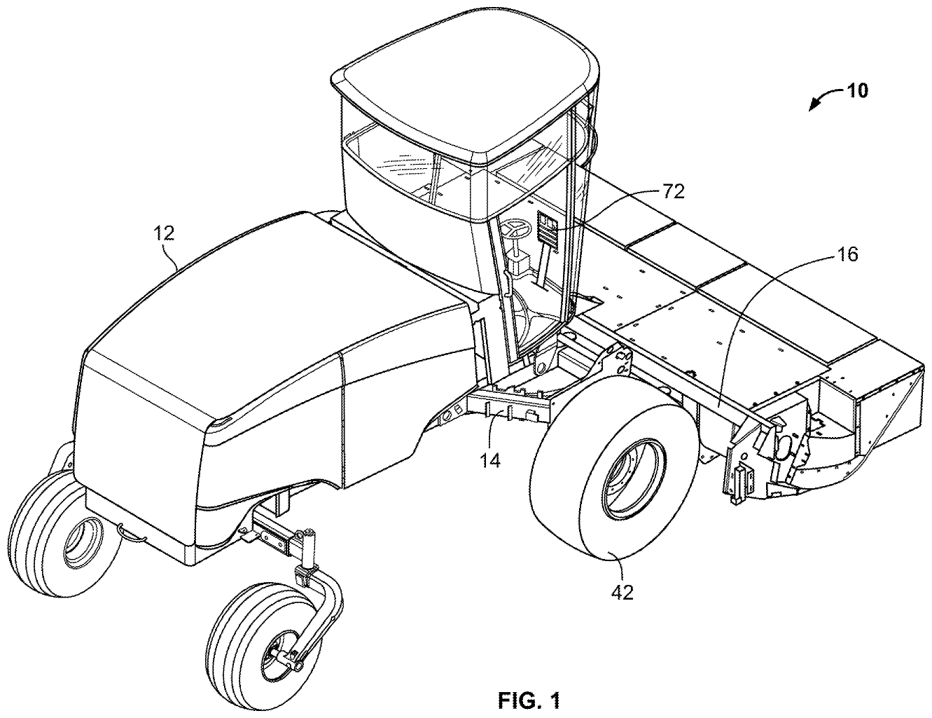

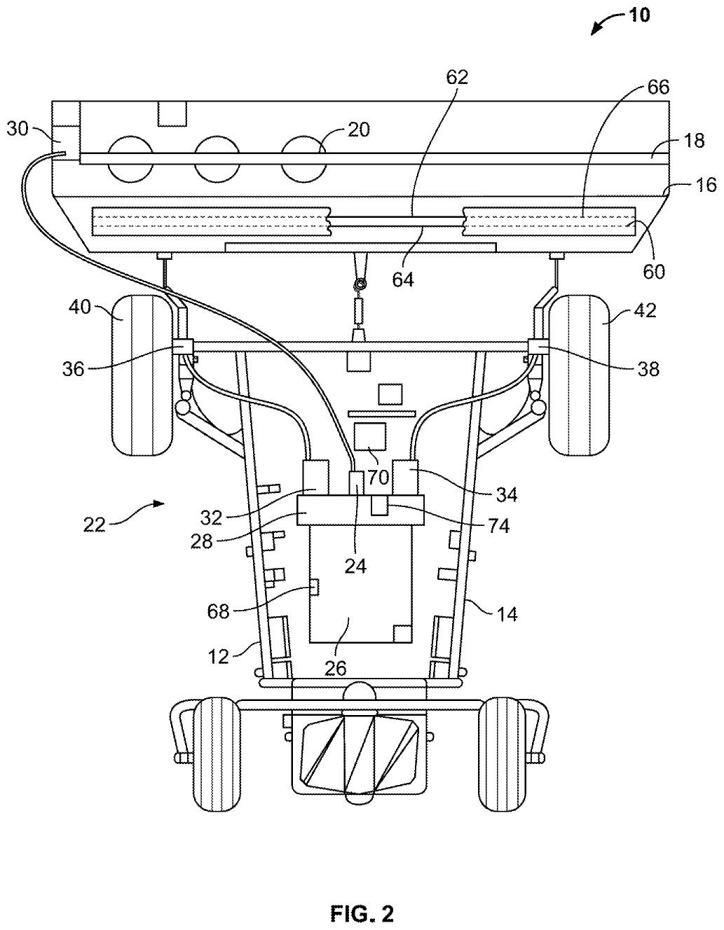

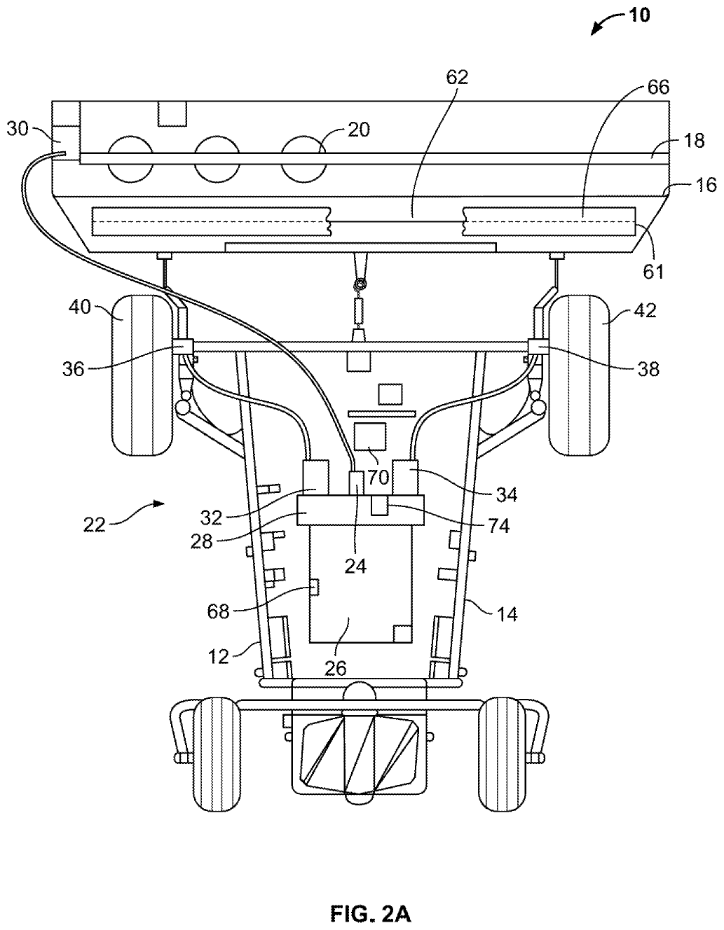

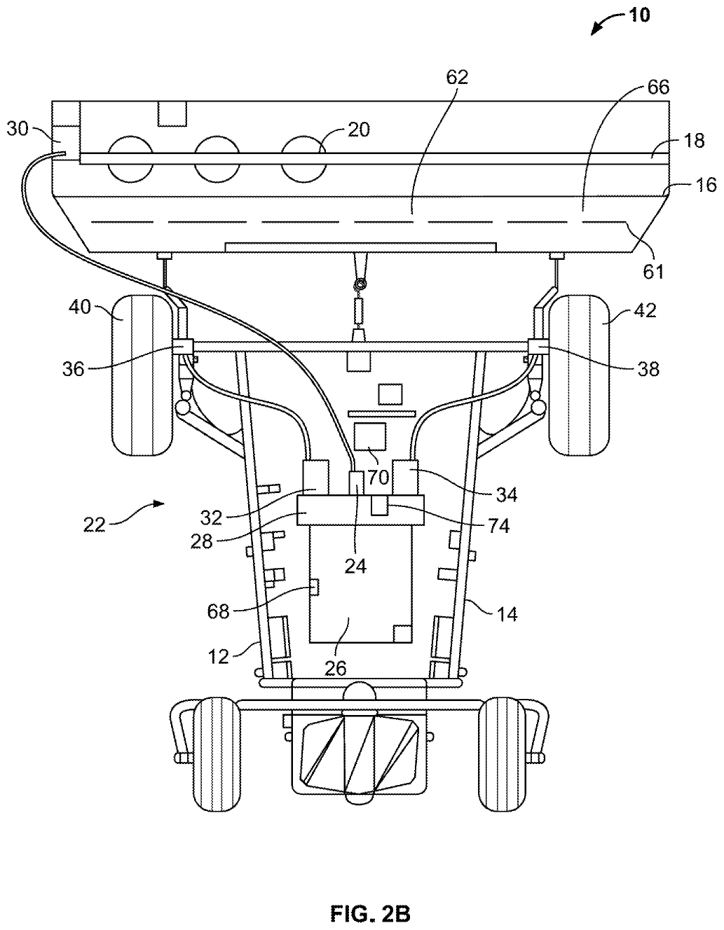

FIG. 1 depicts an example embodiment of a harvester 10 according to the invention. Harvester 10 includes agricultural equipment such as combines, windrowers, mowers and balers. In this example, harvester 10 is self-propelled and comprises a tractor 12 having a chassis 14. As shown in FIG. 2, a frame 16 is mounted on chassis 14 and supports a cutter bar 18 mounted on the frame. A plurality of cutting elements 20, in this example rotating discs having cutting blades thereon, are mounted on the cutter bar. A drive system 22 is operatively associated with the cutter bar and provides the motive power which turns the discs 20 to cut the crop. Drive system 22 comprises a hydraulic pump 24 driven by the tractor engine 26 through a gear box 28. Pump 24 is in fluid communication with a hydraulic motor 30 mounted on frame 16 which is connected to the discs 20 via a transmission such as a belt drive (not shown) to rotate the discs. Tractor 12 is a differentially steered vehicle comprising a drive system having left and right hydraulic pumps 32 and 34 powered by the engine 26 through the gear box 28, the pumps 32 and 34 being in fluid communication with respective left and right hydraulic motors 36 and 38 which power respective left and right wheels 40 and 42 to propel and steer the tractor 12.

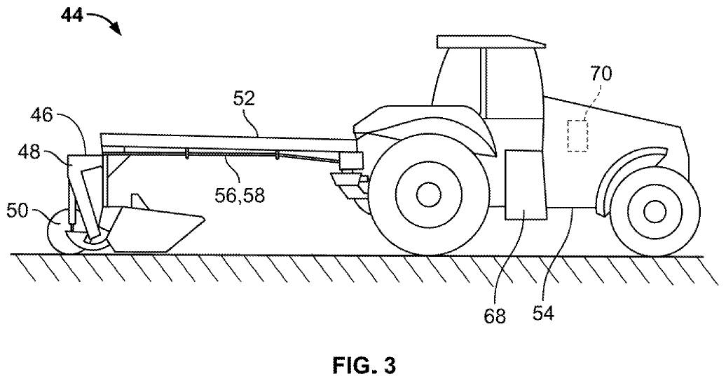

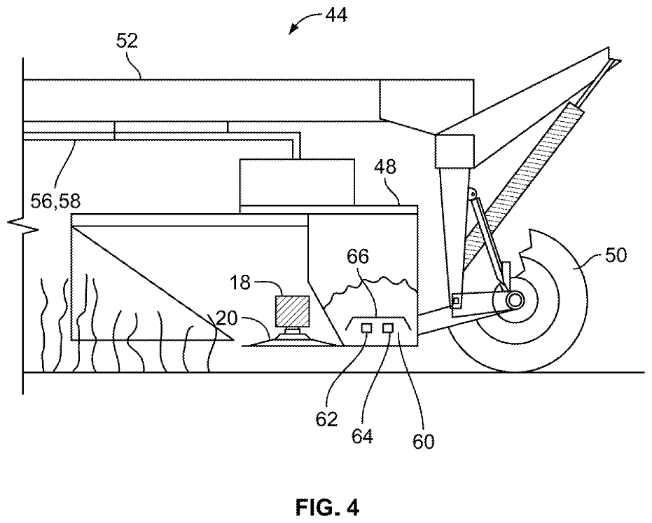

FIG. 3 shows another example embodiment of a harvester 44 according to the invention. Harvester 44 is a towed mower 46 comprising a frame 48 on which two ground engaging wheels 50 are mounted. A tongue 52 is also attached to frame 48, the tongue being attachable to a tractor 54 for drawing the harvester. As shown in FIG. 4, harvester 44 comprises a cutter bar 18 mounted on the frame 48. A plurality of cutting elements 20, in this example rotating discs having cutting blades thereon, are mounted on the cutter bar. As shown in FIGS. 3 and 4, a drive system 56 is operatively associated with the cutter bar and provides the motive power which turns the discs 20 to cut the crop. Drive system 56 comprises a power take-off shaft 58 which extends along the tongue 52. One end of shaft 58 is coupled to the tractor's engine (not shown), the opposite end being connected to the discs 20 via a transmission such as a belt drive (not shown) the engine being used to rotate the discs.

As shown in FIGS. 2 and 4, each harvester embodiment 10 and 44 further comprises a system 60 for determining the crop cut quality. Cut quality system 60 comprises first and second electrodes 62 and 64 positioned in spaced relation to one another on the harvester. In both example embodiments the electrodes are mounted on the respective frames 16 (self-propelled harvester 10) and 48 (towed harvester 44). The electrodes 62 and 64 are positioned downstream from the cutter bar 18, meaning that they are behind the cutter bar 18 and encounter the crop stubble after cutting. Electrodes 62 and 64 are electrically insulated from one another and from the respective frames 16 and 48. In one embodiment (shown), the electrodes 62 and 64 are elongate electrical conductors, for example, copper bars, arranged parallel to and spanning approximately the same width as the cutter bar 18. This configuration allows the entire swath of the cut to be monitored for quality.

FIG. 2A illustrates another cut quality system embodiment, system 61, applicable to each harvester embodiment 10 and 44. System 61 comprises a single electrode 62 positioned on the harvester. In both example harvester embodiments the electrode 62 is mounted on the respective frames 16 (self-propelled harvester 10) and 48 (towed harvester 44). The electrode 62 is positioned downstream from the cutter bar 18, meaning that it is behind the cutter bar 18 and encounters the crop stubble after cutting. Electrode 62 is electrically insulated from the harvester, specifically from the respective frames 16 and 48. In one embodiment (shown), the electrode 62 is an elongate electrical conductor, for example, a copper bar, arranged parallel to and spanning approximately the same width as the cutter bar 18. This configuration allows the entire swath of the cut to be monitored for quality. In another embodiment, shown in FIG. 2B, the system 61 comprises a plurality of single electrodes 62, each having a span less than the width of the cutter bar 18. The shorter electrodes 62 extend across the frame and are arranged parallel to the cutter bar 18. Together the plurality of electrodes 62 span the same width as the cutter bar 18. Each electrode is electrically insulated from the harvester. This configuration would permit identification of individual cutter discs 20 which are malfunctioning, and would allow cut quality to be based upon a comparison of the swaths measured by each single electrode.

As shown in FIGS. 2 and 4, it is advantageous to surround a portion of the electrodes 62, 64 with a shroud 66. The shroud 66 is configured such that the portion of the electrodes 62, 64 facing away from the crop stubble are covered, leaving portions of the electrodes facing the crop stubble uncovered and engageable with the crop stubble to determine the crop cut quality as described below.

Cut quality system 60 further comprises a voltage source 68. The voltage source could comprise, for example, the tractor's electrical system including an electrical battery and an alternator or generator. The voltage source 68 applies a voltage difference (e.g., 12 volts) between the first and second electrodes 62 and 64.

Similarly, cut quality system 61 also comprises a voltage source 68. The voltage source could comprise, for example, the tractor's electrical system including an electrical battery and an alternator or generator. The voltage source 68 applies a voltage difference (e.g., 12 volts) between the single electrode 62 and the harvester (10 or 44). For example, as the single electrode 62 is electrically insulated from the frame on which it is mounted, the voltage difference for system 61 may be applied between the single electrode 62 and the harvester frame. It is advantageous to ground the frame to the negative pole of the voltage source.

As part of cut quality system 60, a controller 70, positioned in the tractor (12 or 54) or on the towed mower (46) is in communication with the electrodes 62 and 64 either via electrical conductors or wirelessly and is adapted to generate signals indicative of an electrical parameter between the first and second electrodes. Example electrical parameters include a voltage drop across the electrodes 62 and 64 or an electrical current flowing between the electrodes. The signals generated by the controller 70 provide a measure of the cut quality as explained below. Similarly for cut quality system 61 controller 70 is in communication with the single electrode 62 either via electrical conductors or wirelessly and is adapted to generate signals indicative of an electrical parameter between the single electrode and ground. Again, example electrical parameters include a voltage drop across the single electrode 62 and the harvester frame (which is at ground) or an electrical current flowing between the single electrode and the harvester frame. The signals generated by the controller 70 provide a measure of the cut quality as explained below.

Controller 70 is advantageously a microprocessor based device, for example, a programmable logic controller which communicates with a display device 72, shown in FIG. 1. Display device 72 is advantageously positioned within the cabs of the tractors 12 and 54 and is adapted to receive the signals from the controller 70 and provide a visual indication of the signals to the operator of the harvester. Display device 72 could be a simple gauge, or a video monitor for example. Controller 70 is also in communication with an actuator 74 operationally associated with the drive system 22 of the cutter bar 18 as shown in FIG. 2. Actuator 74 is adapted to receive signals from the controller 70 to effect adjustments in the speed of the cutting elements of the cutter bar pursuant to a control method executed by the controller in response to the electrical parameters measured between the electrodes 62 and 64 as explained below. By way of example, actuator 74 could be a hydraulic actuator which controls the angle of a swash plate in the pump 24 of the drive system 22.

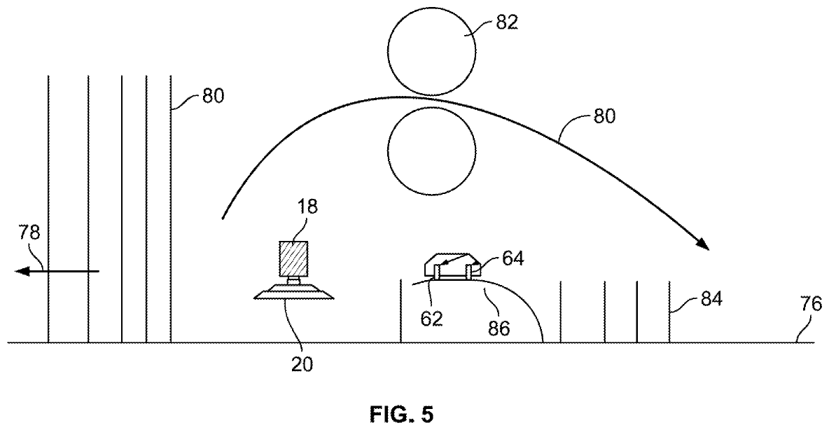

FIG. 5 schematically illustrates operation of an example cut quality system 60 according to the invention. As the cutter bar 18 passes over the ground 76 in the direction indicated by arrow 78 (either towed, with mower 46, or carried by tractor 12) the cutting elements 20 cut crop 80 and throw the cut crop 80 either behind or to the side of the mower 46 or tractor 12 using rotating conditioning rolls 82 and conveyors (not shown) as is well understood. Stubble 84, 86 remains behind the cutter bar 18. If the cut is clean, the stubble 84 is uniformly lower than the height of the electrodes 62 and 64 above the ground 76 and no contact is made between the stubble 84 and the electrodes 62 and 64. The electrical parameter between the electrodes 62 and 64 is undisturbed, and this parameter, for example, a voltage drop across the electrodes or an electrical current between the electrodes, is measured by the controller 70. Controller 70 communicates this measurement via signals to the display device 72, which the operator interprets as indicating acceptable cut quality by the harvester. However, as shown at 86, the stubble is unevenly cut and is longer than the uniformly cut stubble of 84. The stubble 86 contacts the electrodes 62 and 64, thus changing the electrical parameter between the electrodes. For cut quality system 61 the stubble 86 would contact the single electrode 62 and the frame of the harvester, thereby changing the electrical parameter between the single electrode and ground. Controller 70 measures this change in the electrical parameter, for example, a decrease in the voltage drop between the electrodes 62 and 64 (or between single electrode 62 and ground) as the stubble makes contact and closes a circuit, or the sudden presence or increase in the electrical current between the electrodes 62 and 64 (or between the single electrode and the harvester frame at ground potential). If a plurality of short electrodes (either electrode pairs 62 and 64 or single electrodes 62) are used as shown in FIG. 2B, the evaluation of cut quality can be further based upon a comparison of the changes in the electrical parameter between the individual single electrodes or individual electrode pairs. Controller 70 then signals the change in the electrical parameter to the display device, which the operator interprets as indicative of poor cut quality, and takes corrective action. Corrective action may be, for example, to increase the speed of the cutting elements 20, decrease the speed of the harvester 10 or 44, or a combination of both actions. This reaction to the display of poor cut quality may be automated, as the controller may be programmed to command actuator 74 to increase the speed of the cutter elements. The increase in cutter element speed may be proportional to the change in the electrical parameter between the electrodes 62 and 64 for example.

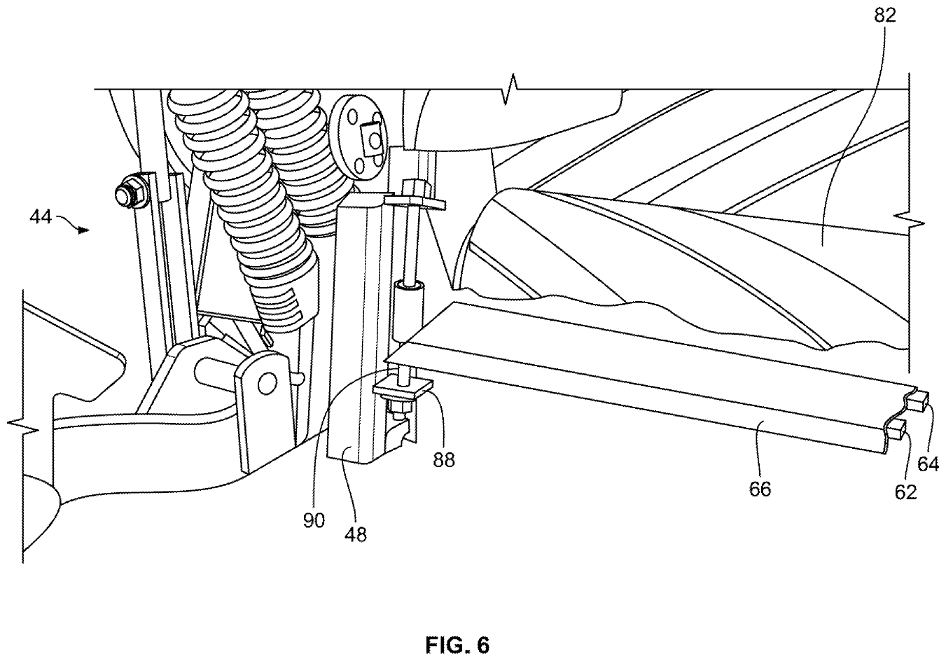

It is advantageous to permit adjustment of the height of the electrodes 62 and 64 (or the single electrode 62) above the ground. FIG. 6 illustrates an example adjustable mount 88 for mounting the electrodes 62 and 64 to the frame 48 of a harvester 44. In this example, a hydraulic piston 90 is used to set and adjust the position of the electrodes 62 and 64 to accommodate different cut heights of different crops. A similar mechanism may be used on harvester 10.

Harvesters according to the invention are expected to provide more uniform cut quality because the cut quality system permits continuous monitoring of cut quality and indications of remedial action which should be taken to maintain a high quality cut.

What is claimed is:

1. A system for determining the cut quality of a crop by a harvester, said system comprising:
an electrode positionable on said harvester, said electrode being electrically insulated from said harvester;
a voltage source applying a voltage difference between said electrode and said harvester;
a controller in electrical communication with said electrode and said harvester, said controller being adapted to measure an electrical parameter between said electrode and said harvester and generate signals indicative of said electrical parameter, wherein said signals are a measure of cut quality of said crop by said harvester.

2. The system according to claim 1, wherein said controller measures said electrical parameter between said electrode and a frame of said harvester.

3. The system according to claim 1, wherein said electrical parameter comprises a voltage drop across said electrode and said harvester.

4. The system according to claim 1, wherein said electrical parameter comprises a current between said electrode and said harvester.

5. The system according to claim 1, wherein said electrode comprises an elongate electrical conductor.

6. The system according to claim 5, further comprising a shroud surrounding a portion of said elongate electrical conductor.

7. The system according to claim 1, further comprising a display device in communication with said controller, said display device adapted to receive said signals from said controller and display said signals to an operator of said harvester.

8. A system for determining the cut quality of a crop by a harvester, said system comprising:
first and second electrodes positionable in spaced relation on said harvester, said electrodes being electrically insulated from one another and from said harvester;
a voltage source applying a voltage difference between said first and second electrodes;
a controller in electrical communication with said electrode, said controller being adapted to measure an electrical parameter between said first electrode and said harvester and generate signals indicative of said electrical parameter, wherein said signals are a measure of cut quality of said crop by said harvester.

9. The system according to claim 8, wherein said electrical parameter comprises a voltage drop across said first and second electrodes.

10. The system according to claim 8, wherein said electrical parameter comprises a current between said first and second electrodes.

11. The system according to claim 8, wherein said first and second electrodes comprise first and second elongate electrical conductors.

12. The system according to claim 11, further comprising a shroud surrounding a portion of said first and second elongate electrical conductors.

13. The system according to claim 8, further comprising a display device in communication with said controller, said display device adapted to receive said signals from said controller and display said signals to an operator of said harvester.

14. A harvester for cutting a crop, said harvester comprising:
a frame;
a cutter bar mounted on said frame, a plurality of cutting elements being mounted on said cutter bar;
an electrode mounted on said frame downstream from said cutter bar, said electrode being electrically insulated from said frame, said electrode facing stubble of said crop;
a voltage source applying a voltage difference between said electrode and said frame;
a controller in electrical communication with said electrode and said frame, said controller being adapted to measure an electrical parameter between said electrode and said frame and generate signals indicative of said electrical parameter, wherein said signals are a measure of cut quality of said crop by said harvester.

15. The harvester according to claim 14, wherein said electrical parameter comprises a voltage drop across said electrode and said frame.

16. The harvester according to claim 14, wherein said electrical parameter comprises a current between said electrode and said frame.

17. The harvester according to claim 14, wherein said electrode comprises an elongate electrical conductor.

18. The harvester according to claim 17, wherein said elongate electrical conductor spans the same width as said cutter bar.

19. The harvester according to claim 14, further comprising a plurality of said electrodes.

20. The harvester according to claim 19, wherein each of said electrodes comprises an elongate electrical conductor, each said electrical conductor having a span less than the width of said cutter bar.

21. The harvester according to claim 20, wherein said plurality of said electrical conductors spans the same width as said cutter bar.

22. The harvester according to claim 14, further comprising a display device in communication with said controller, said display device adapted to receive said signals from said controller and display said signals to an operator of said harvester.

23. The harvester according to claim 14, further comprising an adjustable mount positioned between said frame and said electrode for adjusting a position of said electrodes relatively to said stubble.

24. The harvester according to claim 14, further comprising:
at least two ground engaging wheels mounted on said frame;
a tongue attached to said frame, said tongue being attachable to a tractor for drawing said harvester.

25. The harvester according to claim 24, further comprising:
a drive system operationally associated with said cutter bar;
an actuator operationally associated with said drive system, said actuator being adapted to control a cutting speed of said cutter bar via said drive system; wherein
said actuator receives said signals from said controller and adjusts said cutting speed of said cutter bar pursuant to a control method executed by said controller.

26. The harvester according to claim 14, further comprising:
a tractor having a chassis; wherein
said frame is mounted on said chassis.

27. The harvester according to claim 26, further comprising:
a drive system operationally associated with said cutter bar;
an actuator operationally associated with said drive system, said actuator being adapted to control a cutting speed of said cutter bar via said drive system; wherein
said actuator receives said signals from said controller and adjusts said cutting speed of said cutter bar pursuant to a control method executed by said controller.

28. A harvester for cutting a crop, said harvester comprising:
a frame;
a cutter bar mounted on said frame, a plurality of cutting elements being mounted on said cutter bar;
first and second electrodes mounted in spaced relation on said frame downstream from said cutter bar, said electrodes being electrically insulated from one another and from said frame, said electrodes facing stubble of said crop;
a voltage source applying a voltage difference between said first and second electrodes;
a controller in electrical communication with said first and second electrodes, said controller being adapted to measure an electrical parameter between said first and second electrodes and generate signals indicative of said electrical parameter, wherein said signals are a measure of cut quality of said crop by said harvester.
